(19) United States
(12) Patent Application Publication
(10) Pub. No.: US 2006/0269899 A1
(43) Pub. Date: Nov. 30, 2006

(54) Sectional or Modular Impression Tray

(76) Inventor: Giancarlo Venneri, Cosenza (IT)

Correspondence Address: SMITH HOPEN, PA, 180 PINE AVENUE NORTH, OLDSMAR, FL, 34677, US

(21) Appl. No.: 11/383,282

(22) Filed: May 15, 2006

Related U.S. Application Data
(63) Continuation of application No. PCT/IT04/00616, filed on Nov. 10, 2004.

(30) Foreign Application Priority Data
Nov. 10, 2004 (WO) 2005/046504 A2

(51) Int. Cl. A61C 9/00

(52) U.S. Cl. 433/41

(57) ABSTRACT

Sectional or modular impression tray characterized by the fact that said impression tray is composed by a “U” shaped plain base with a handle for the grasp (1), and an “oval hole” (3) set at the two final distal points of the “U”, and its vestibular arc (23) with a rectangular shaped “hole for the handle” (6) located down in the center to insert the handle for the grasp (1) and its two “internal guides” (7) to stabilize the impression fray, with a “hook for the pliers” (8) set just above the grasp handle hole, and to obtain the final impression fray this vestibular arc fits with one base through the “hole for the handle” (6).

### CROSS REFERENCE TO RELATED APPLICATIONS

This application claims priority to currently pending WIPO Patent Application WO 2005/046504 A2, entitled, “SECTIONAL OR MODULAR IMPRESSION TRAY”, filed Nov. 10, 2004 which claims priority to CZ2003A000016 having a filing date of Nov. 13, 2003.

In dentistry to obtain models of patient teeth and mucous it is necessary to take the impression to prepare fixed, movable and orthodontic dental prosthesis, or for other particular purposes. The perfect accuracy of the obtained impression determines the dentist's quality work.

The ultimate impression flow is gotten by means of a tray, impression material and plaster model.

The IMPRESSION TRAY (or spoon) is a metal or plastic tool that contains the impression material.

The IMPRESSION MATERIAL applied by means of the impression tray into the oral cavity of a patient gives the negative copy of his teeth and oral mucous.

The PLASTER MODEL is the exact copy of the patients' teeth and mucous and it is gotten by the hardening of the liquid plaster poured into the impression material.

The removal of the “plaster model” out of the impression material involves the risk of fractures of the same model caused by the rigid characteristic of the “impression tray”, by the insufficient or complete absence of elasticity of the “impression material” and it is also caused by the plaster model characteristic (very hard and breakable, for shape the teeth are sometimes separated, long or/and thin).

The breaking of a plaster model, during the removal from the “impression tray”, causes problems to the dentist who has only two opportunities: to glue the fractures with the risk of jeopardizing the accuracy of his work or to take again the impression of the patient calling him back to the dental surgery, with waste of time, loss of material and always with the risk that the breaking will occur again.

Finally in these cases, there is the most serious risk of losing the professional competence in the patient's opinion.

The first impression tray (rigid stock or spoon) in the picture 1 was invented by DE LA BARRE e MAURY in 1820, it was made in wood, tin, lead, steel or aluminum and in only one piece until today that if, from one point of view, it takes care of the mouth-dimension changeability it doesn't take in consideration the different shapes of the teeth.

The MODULAR-TRAY of this invention for dental impressions, of the present patent application, it is composed of a base and an arc (or two semiarcs). An “upper base” for the impression of the upper teeth and a “lower base” for mandibular teeth impressions.

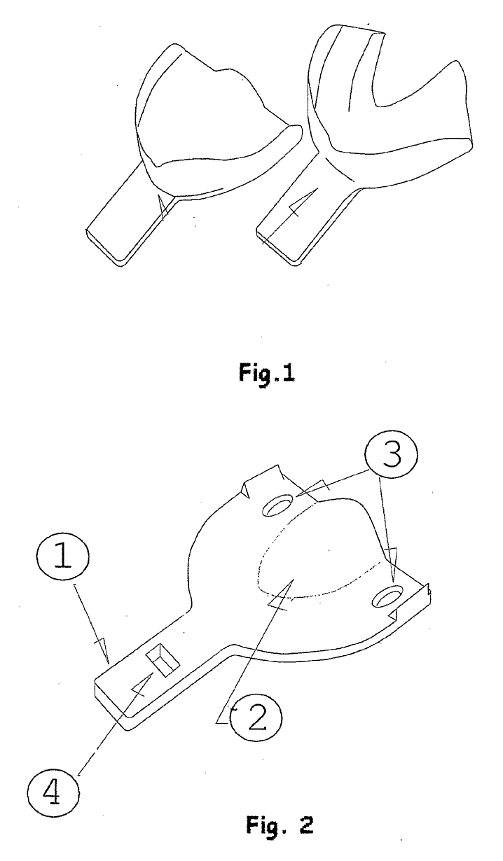

The “upper base”, in FIG. 2, is almost flat to form a complete U, with a handle for the grasp (1) and with an internal swelling (palatal rise) (2), an “oval hole” (3) is at the two distal extremities for the attack of the semiarchs; in the center of the handle there is a rectangular hole (4) to ease the detaching of the arch from the base.

The “lower base” in FIG. 3, similar to the upper one, instead of the palatal rise has an open space sufficient for the tongue and two internal wings (5) (or tongue wings) to ease the adherence grip of the impression material to the teeth and to the mucous.

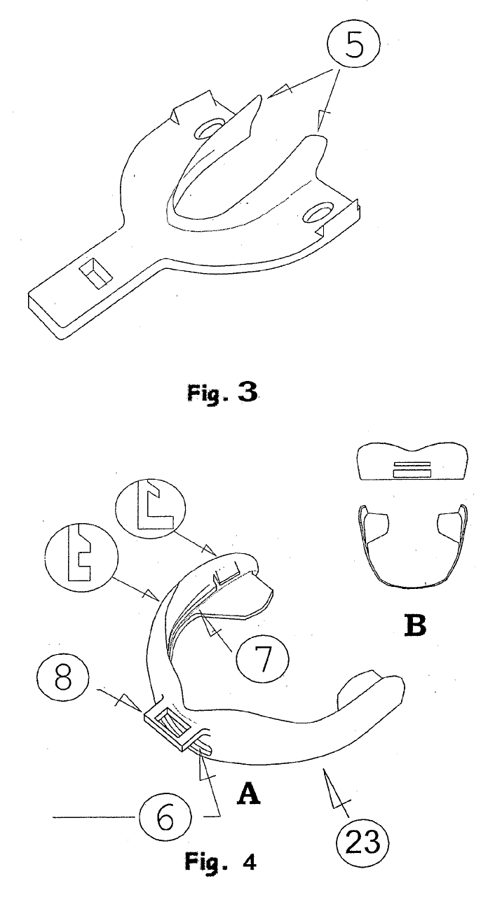

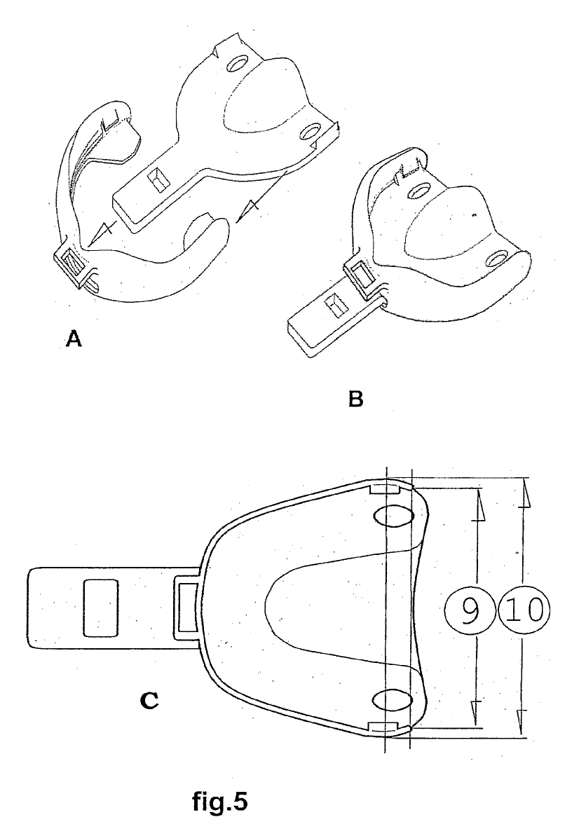

The VESTIBULAR ARC (23) in FIG. 4 (that winds the teeth in the vestibular zone of the mouth) has a rectangular “hole for the handle” (6) located down in the center for the passage of the “handle of the base” (1) and it has two “internal guides” (7) to stabilize the impression tray, just above the hole for the handle there is a “hook for the pliers” (8); to obtain the complete impression tray the vestibular arc will be assembled with the base through the “hole for the handle” (6) and the “internal guides” (7) see FIGS. 4 and 5.

Bases and arcs form the modules, these together become a unique piece because, in the distal part, the width of the arc final section (9) in FIG. 5C is inferior than the width of the distal middle part (10) in FIG. 5C of the invention.

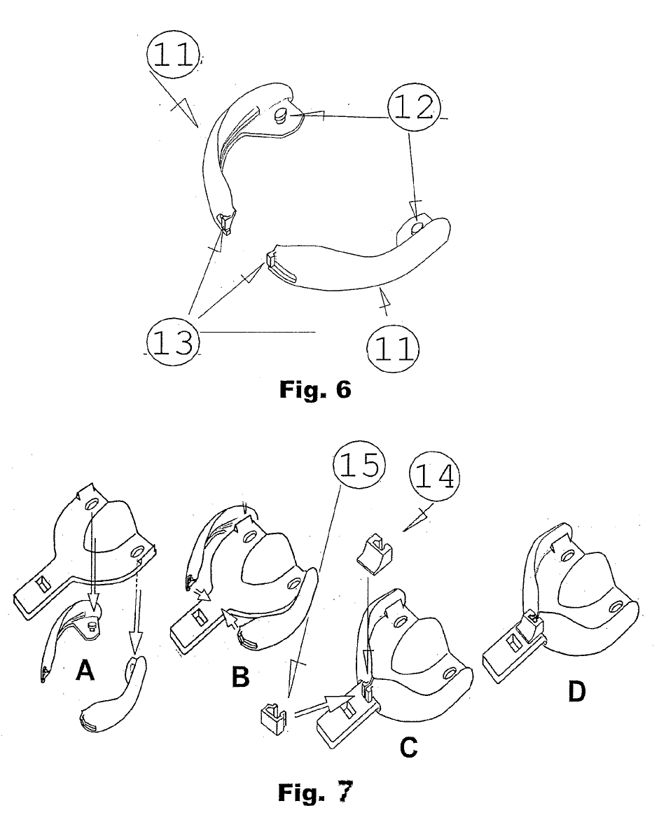

The right and left SEMI-ARCS (11) in FIG. 6 form a complete arch and have two “oval pivots” (12) (shaped like a mushroom with an oval head) and two “locking wings” (13) set in the front part.

To form the complete impression tray with the two semi-arcs the “oval pivots” (12) are inserted into the “oval holes” (3) set on the base, see FIG. 7AB, then the “mesial extremities” are joined, as shown in FIG. 7BC, finally the “semi-arc locker” (14 e 15) is let slide on the “locking wings” (13) see FIG. 7CD.

Bases, arcs or semiarcs may be perforated or not to ease the adherence of the impression material.

Another feature of this invention, in the use of the semiarcs, is the choice of “semiarcs lockers” (14-15) to put onto the “wings lockers” (13), of simple craftsmanship and quick usage, one is of vertical insertion (14) and the other is of horizontal insertion (15) see FIG. 7C; only these “semiarcs lockers” (14-15) make possible the use of the semiarcs.

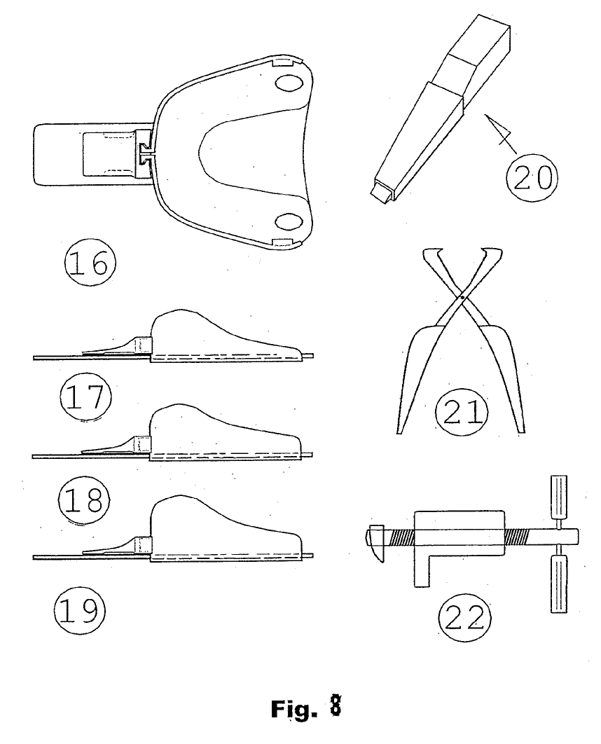

It is obvious that the base and vestibular arcs have different dimensions (16-17-18-19) to fit the different patients' oral cavity see FIG. 8.

The easy detaching of this type of MODULAR TRAY from the impression material it ensures the rescue of the plaster model, with no fractures, in fact the separation of the impression material from the plaster model is extremely easy and without any unforeseen event, since only the traditional impression tray creates the problems already described.

To facilitate the modular tray opening there are a hammer (20) and specific pliers (21) and a “screw extractor” (22) see FIG. 8.

Finally the modular characteristic of this tray simplifies its cleaning and sterilization.

1. Sectional or modular impression tray characterized by the fact that said impression tray is composed by a “U” shaped plain base with a handle for the grasp (1), and an “oval hole” (3) set at the two final distal points of the “U”, and its vestibular arc (23) with a rectangular shaped “hole for the handle” (6) located down in the center to insert the handle for the grasp (1) and its two “internal guides” (7) to stabilize the impression tray, with a “hook for the pliers” (8) set just above the grasp handle hole, and to obtain the final impression tray this vestibular arc fits with one base through the “hole for the handle” (6).

2. Sectional or modular impression tray according to claim 1 characterized by the fact that the base has an internal swelling (palatal swelling) (2) when it is used as upper base.

3. Sectional or modular impression tray according to claim 1 characterized by the fact that the base has an empty space to let room to the tongue when it is used as lower base.

4. Sectional or modular impression tray according to one of the previous claims characterized by the fact that the vestibular arc is made up of two semiarcs, the left one and the right one, that constitute the complete vestibular arc.

5. Sectional or modular impression tray according to claim 4 characterized by the fact that the two semiarcs, the left one and the right one, form a complete arc and have at the two distal extremities two oval pivots (12), (shaped like a mushroom with a round stalk and an oval head) and two wings lockers (13) set in the front of it.

6. Sectional or modular impression tray according to claims 4 and 5 characterized by the fact that in order to form the final impression tray (by means of the two semiarcs) the oval pivots (12) are inserted into the oval holes (3) set at the base, the mesial extremities are joined and finally the semiarcs locker (14-15) are let slide onto the wings lockers (13).

7. Sectional or modular impression tray according to claim 4, 5 or 6 characterized by the fact that to ease the opening of the modular impression tray there are a hammer (20), a pair of specific pliers (21) and a screw shaped extractor (22).
